(19) United States
(12) Patent Application Publication
(10) Pub. No.: US 2008/0167847 A1
(43) Pub. Date: Jul. 10, 2008

(54) Device for Simulating a Medium Evolution by Asynchronous and Chaotic Processing in the Presence of Autonomous Interacting Entities and a Multi-Agent System

(75) Inventors: Marc Parenthoen, Brest (FR); Jacques Tisseau, Brest (FR); Thomas Jourdan, Brest (FR); Christian Charles, Plougonvelin (FR)

Correspondence Address: OBLON, SPIVAK, MCCLELLAND MAIER & NEUSTADT, P.C., 1940 DUKE STREET, ALEXANDRIA, VA, 22314, US

(73) Assignees: Cerival, Plougastel (FR); Ecole Nationale D'Ingenieurs de Brest, Brest Cedex 3 (FR)

(21) Appl. No.: 11/628,001

(22) PCT Filed: Sep. 22, 2004
(86) PCT No.: PCT/FR2004/002384

§ 371 Date: Sep. 17, 2007

(30) Foreign Application Priority Data
Jun. 2, 2004 (FR) 0405943

(51) Int. Cl. G06G 7/48

(52) U.S. Cl. 703/6

(57) ABSTRACT

A computer supporting an active object program in a multi-purpose mode comprises a device (D) for simulating the time evolution of a medium. Said device (D) comprises a software dedicated for simulating by objects the joint evolution of certain activated objects comprising enaction objects defining autonomous spatiotemporal entities each of which represents a physical phenomenon and, when activated, interacts in a multi-agent medium via state objects defining interaction mediators providing a topological spatiotemporal support which forms a virtual environment representing a simulated medium and makes it possible to detect the interactions between the entities in space and in time and (ii) a simulation manager capable to operate by sequences on a selection of the enaction objects and to activate each enaction object only once for each sequence according to an order varying at least partially in a random manner from one sequence to the other, thereby enabling the spatiotemporal interactions dynamically evolve sequence by sequence between the enaction objects.

The invention relates to the computer simulation (or modelling) of the time evolution of media which are the subject of physical phenomena, such as for example liquid, gaseous, solid, particulate media and the like.

As the skilled man knows, modelling the interactive phenomenological animation of a medium in virtual reality is a particularly difficult task, particularly when the dimensions of the medium are substantial and it has to be carried out in real time.

For example, in the case of a liquid medium such as the sea, this difficulty results chiefly from the fact that a number of points of view have to be reconciled simultaneously. More precisely, the modelling requires reconciliation of the maritime, oceanographical and computer graphics points of view. In fact, sailors use a specific vocabulary to describe the sea as a heterogeneous medium (body of water) on which they observe localised phenomena which enable them to guide their navigation strategies. For their part, the oceanographers and engineers model the phenomena in the form of a complex system within which a number of models are superimposed on one another.

In order to model the physical phenomena, computer graphics experts use computer graphics models generally based on differential equations such as Navier-Stokes equations, for example. In fact, the algorithmic complexity of the direct digital solving of these differential equations does not allow the animation of media of relatively large dimensions compared with the dimensions of its components (for example several square kilometres in the case of a body of water). Moreover, solving differential equations of this kind requires conditions at the initial limits which makes them unsuitable for interactivity.

In the absence of an analytical solution, the computer simulation therefore has to rely on iterative methods (known as particulate or spectral methods) which pass from a current state of the system under consideration to a following state of this same system. Each system is generally broken down into sub-systems or meshes the respective evolutions of which are calculated in parallel and synchronously. Consequently, the state of the system at the moment T+1 results from the parallel application of the selected phenomena to the state of each mesh at the moment T, without being preoccupied with the consequences which this may lead to between meshes.

It has certainly been proposed (for example in the publication by D. Hinsinger et al “Interactive animation of ocean waves”, Symposium on Computer Animation (SCA), pages 161-166, 2002, and in the publication by S. Thon “Ocean waves synthesis using a spectrum-based turbulence function”, IEEE-Computer Graphics International (CGI), pages 65-74, Switzerland, 2000, IEEE Computer Society) to combine the particulate and spectral iterative methods, by using the direct local digital resolutions of the differential equations (of Navier-Stokes). However, this combination does not always make it possible to take account simultaneously, for a heterogeneous medium, of the local effects caused by various phenomena when the dimensions of the medium are large on the scale of its components. For example, in the case of a body of water such as the sea, it is not always possible to take account simultaneously of the local effects caused, over one or more dozens of square kilometres, by phenomena such as wave breaking, wind, currents and bathymetry, on wave groups of all the wavelengths, which are essential for the simulation to make sense for sailors and remain physically credible for oceanographers.

The aim of the invention is thus to improve the situation.

To this end it proposes a device for simulating the time evolution of a medium, which is suitable for being implanted in a computer capable of supporting a programming by activated objects in a multi-taste mode.

This device is characterised in that it comprises:
software for simulating by objects the joint evolution of at least some of the activated objects, comprising first objects known as “enaction” objects defining autonomous spatio-temporal entities each of which represents a physical phenomenon and, when activated, interacting in a multi-agent system (SMA) via second objects known as state objects defining interaction mediators which provide a topological spatio-temporal support constituting a virtual environment representing the medium simulated and making it possible to detect the interactions between entities in space and time (or spatio-temporal interactions), and
a simulation manager capable of operating by sequences on a selection of enaction objects and of activating each enaction object once during each sequence, in an order which varies at least partially in a random manner from one sequence to the other, so as to cause the spatio-temporal interactions between enaction objects to evolve dynamically sequence by sequence.

The device according to the invention thus operates in asynchronous mode, owing to the fact that the respective states of the activated objects vary one after the other within each sequence, taking account of the respective states of the other activated objects, and in chaotic mode, owing to the fact that the order of processing of each activated object varies in random fashion from one sequence to the other. It is also possible to activate or suppress at any time (i.e. in real time) one or more objects, so as to modify the working conditions and/or the simulated system without having to start the whole simulation all over again, thus giving the device a truly interactive nature.

The simulation software may also comprise enaction objects which define instruments constituting autonomous entities charged with measuring the effects on selected interaction mediators of at least some of the selected physical phenomena (represented by the entities), so as to allow these physical phenomena to be observed in selected locations of the medium.

Each entity (or enaction object) can be defined by first, second and third active objects arranged so as to exert, respectively, a first activity intended to create a topological element consisting of at least one interaction mediator, a second activity intended to attribute properties to each topological element situated within a range of influence of its entity, and a third activity intended to modify the behaviour of its entity as a function of the properties of the topological element which it has created, detected within the medium and attributed by all the entities which make up the medium.

In this case, each autonomous entity (or enaction object) is preferably associated with an adaptable parameterised behaviour model which makes it possible to define a region of the medium where the properties of the topological element which it has created have to be detected, and each moment during which these properties have to be detected.

For example, each detection moment is defined outside two successive time validity ranges during which the behaviour model of the entity in question does not require a fresh detection of the properties of the topological element which it has created in order to remain physically correct.

These time domains are preferably spaced periodically in a selected frequency specific to the entity in question.

Moreover, the simulation software may comprise a scheduler capable of operating either in a real time mode in which it operates according to a selected frequency, or in a virtual time mode, in which it operates periodically but for durations which can vary from one period to the next.

Further features and advantages of the invention will become apparent from studying the detailed description that follows, as well as the accompanying drawings, wherein:

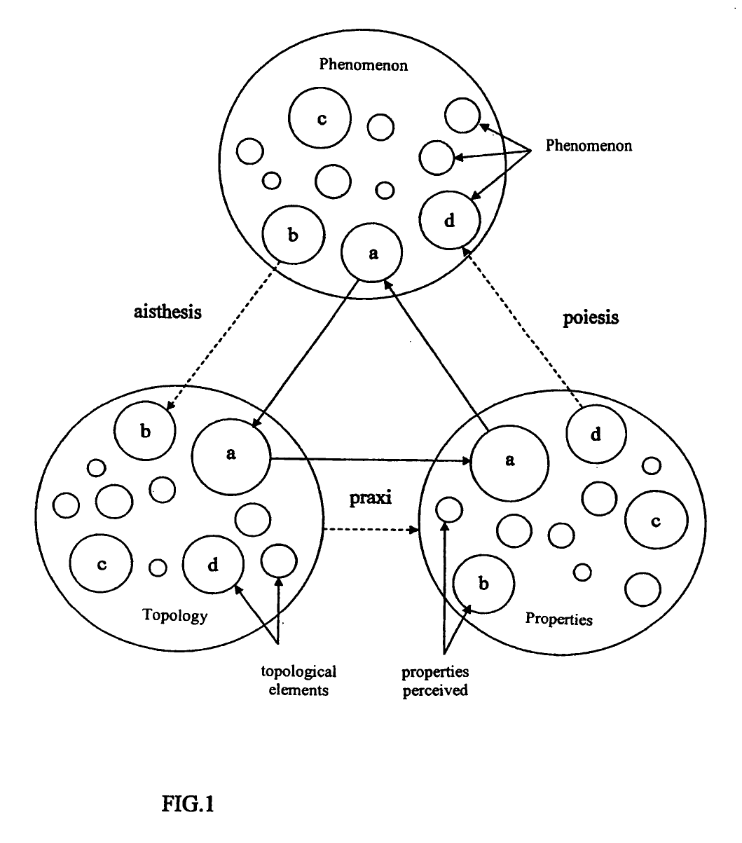

FIG. 1 diagrammatically shows an example of a representation of a phenomenological animation in the form of an organisation of autonomous entities,

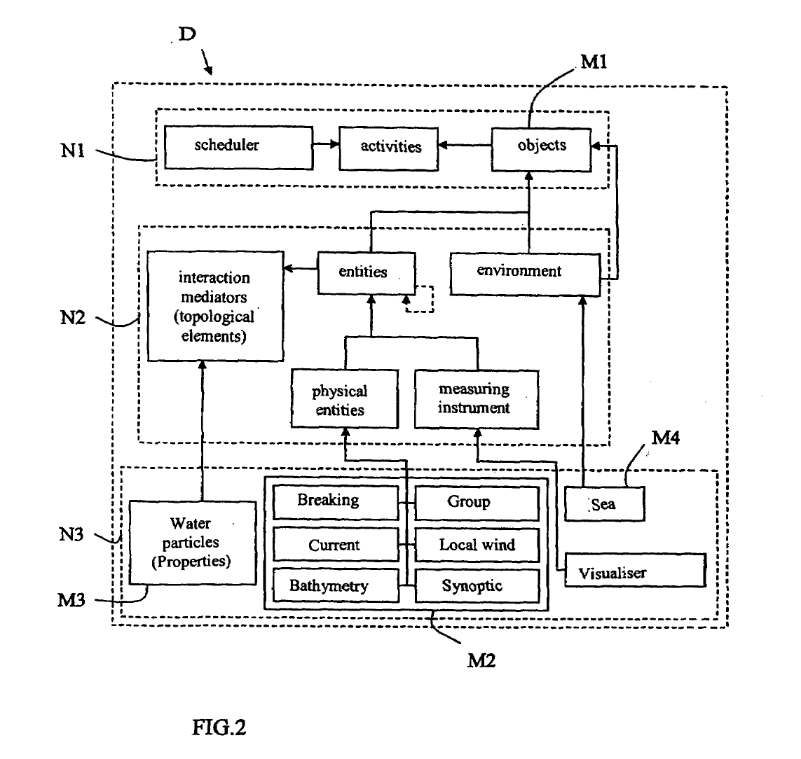

FIG. 2 shows in the form of a UML diagram, an example of a three-level architecture representing the interactive animation of a liquid medium such as the sea, according to the invention,

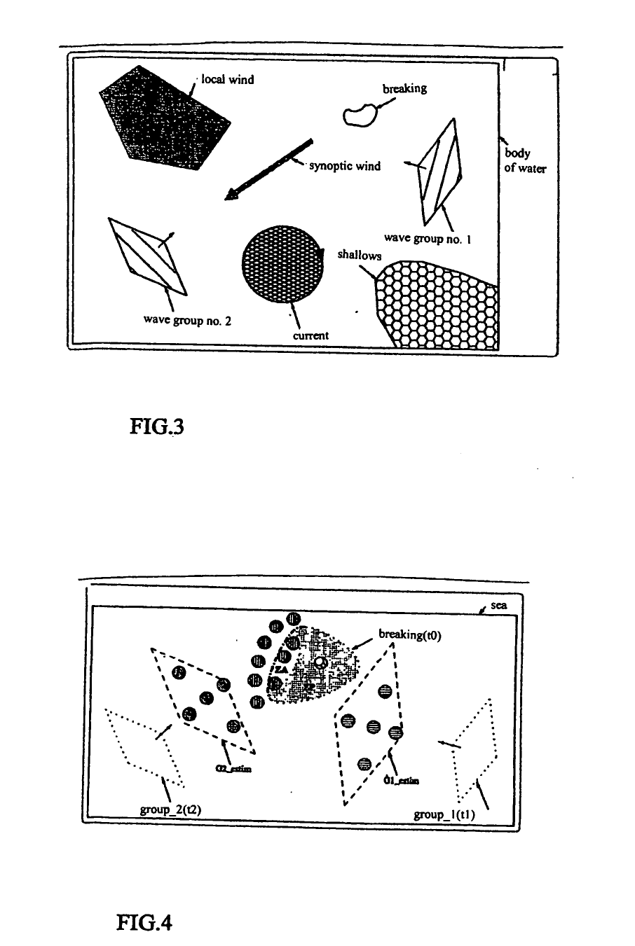

FIG. 3 shows in highly diagrammatic form an example of autonomous physical entities within a liquid medium such as a part of a heterogeneous body of water,

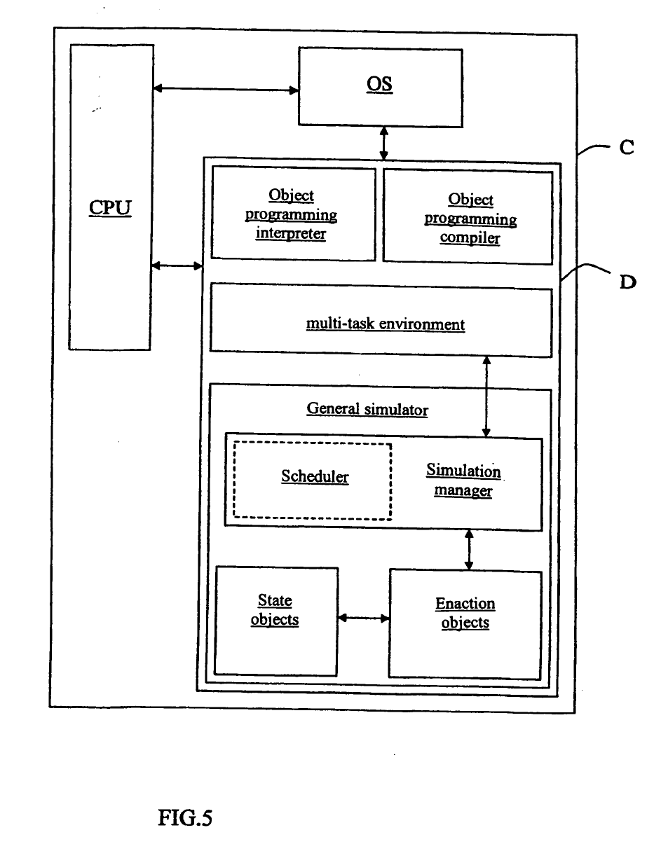

FIG. 4 shows in highly diagrammatic form an example of the creation of a spatio-temporal structure of a liquid medium such as a heterogeneous body of water by three autonomous physical entities, and

FIG. 5 shows in highly diagrammatic form, and in the form of functional blocks, a computer equipped with an embodiment of a simulating device according to the invention.

The accompanying drawings will not only serve to supplement the invention but may also contribute to its definition, in some cases.

The invention relates to a device D dedicated to simulating the interactive phenomenological animation of a heterogeneous medium in virtual reality.

In the description that follows, the medium under discussion will be a body of water, and more precisely an area of sea, as a non-restrictive example.

However, the invention relates to any heterogeneous medium which is subject to physical phenomena causing movements, including those on the (sub-) atomic or particle scale. Consequently, the invention applies to liquid media and notably to bodies of water such as the sea, water courses (rivers and streams), lakes and dock basins, to solid media, particularly for analysing the resistance of materials, and to gaseous media such as the atmosphere or space, for example.

In addition, the invention applies to situations in which a heterogeneous medium is the subject of a combination (or superimposing) of physical phenomena of different kinds. Thus, the invention relates for example to electromagnetic or acoustic waves phenomena and particularly electromagnetic or acoustic waves (action and compatibility) and electromagnetic radiation.

The device D according to the invention, when applied to the sea, makes it possible to reconcile the maritime, oceanographic and computer graphic points of view, so that maritime simulation has meaning for the sailors and remains physically credible in the eyes of the oceanographers.

In fact, sailors use a specific vocabulary to describe the sea as a heterogeneous body of water on which they observe the localised phenomena which will influence their navigation strategies, whereas oceanographers model the phenomena in the form of a complex system within which a number of models are superimposed.

By the term “localised phenomena” are meant here physical phenomena such as a wave group, a breaking of waves, an interaction between at least two wave groups, an interaction between a wave group and a breaking, an interaction between a wave group and a wind, an interaction between a wave group and a current, or an interaction between a wave group and a depth.

Corresponding to each phenomenon modelled there is at least one physical model depending on at least one parameter. It is important to note that each physical phenomenon is modelled independently of the other physical models.

In the table that follows, the principal physical phenomena used by sailors are compiled, as a non-restrictive example, so as to correspond to the physical models used in physical oceanography and to the associated parameters:

| Phenomenon modelled | Physical models | Parameters |
|---|---|---|
| Wave group | Waves pinpointed by a finite | Age, spectrum, number of |
| | extension envelope propagating | main waves, mean wave |
| | along lines | vector, mean position, |
| | Analysis by wavelets using Morlet | group velocity, envelope |
| | 2D analyser | |
| Breaking | Active breaking: breaking | Width of breaking fronts, |
| | criteria, breaking activity | active phase duration, |
| | Passive breaking: progressive | quantity of action, depth |
| | disappearance of turbulence and | of foam, duration of |
| | foam by relaxation | relaxation |
| Group/group | Kinematics: interaction by | Wave vectors, pulsations |
| interactions | breaking | and amplitudes of the |
| | Resonance: interaction of | interacting groups |
| | quadruplets | |
| Group/breaking | Transfers of action and dissipation | Particle/crest velocity, |
| interactions | of short waves by passive foam | depth of foam, dissipated |
| | Elongation of crests | wavelengths |
| | Increase in the number of waves | |
| Group/wind | Age of a state of sea: friction | Field of “wind at altitude” |
| interactions | velocity, transfer of energy into | vectors, wave vectors, |
| | the sea | camber, rate of advance of |
| | | the crest of a wave |
| Group/current | Conservation of crests and action | Field of “surface current” |
| interactions | Refraction and broadening of the | vectors, wave vectors, |
| | groups by current gradients | group pulsations, |
| | | amplitudes and local |
| | | phases of waves |
| Group/depth | Conservation of crests and energy | Bathymetry, mean wave |
| interactions | Dispersive refraction and | vectors, mean pulsations |
| | broadening of groups | of groups, amplitudes and |
| | | local phases of waves |

A more detailed comparison of the vocabularies used respectively by sailors, oceanographers and computer graphics experts can be found for example in the document by M. Parenthoë et al “Les é tats de mer: un é tat de l'art; le marin, l'océanographe et l'infographiste, Actes des 16^{é\acute{m}é} journées de l'AFIG, p. 129-140, Université´ de Paris VIII, 2003.

The device D according to the invention is designed to take account simultaneously for a heterogeneous body of water (in this case a section of the sea, for example 10 sq kilometres) of the local effects of physical phenomena such as breaking of waves, wind, currents or bathymetry, on wave groups of all the wavelengths.

In order to do this, and unlike the simulation devices of the prior art which rely on the numerical solving of differential Navier-Stokes equations on a predefined or adaptive mesh, the device D according to the invention uses first objects known as “enaction” objects defining autonomous entities modelled on the basis of theoretical and experimental results of physical oceanography and interacting in a multi-agent system without using any predefined or adaptive mesh.

By “autonomous entity” is meant here an entity (or enaction object) such as a wave group, an active breaking, a passive breaking, a synoptic (wind), a local wind, a shallow or a current. The oceanographical models of these physical entities and their interactions are described in detail, for example, in the publication by M. Parenthoën et al IPAS : Interactive Phenomenological Animation of the Sea, International Journal of Offshore and Polar Engineering, 2004, the contents of which are hereby incorporated by reference, and will therefore not be described in detail here.

In simple terms, each enaction object (or autonomous entity) is arranged to function according to an active perception step, specifying “where” and “when” there is a need to observe “what”. The activities of the different entities, which will hereafter be referred to as “aisthesis”, structure the spatio-temporal and semantic topology of the medium (in this case the sea) intended to act as an interaction mediator (through the particles of water which make it up).

Each autonomous entity acts on the medium created as a function of its know-how, and adapts to the properties which it perceives actively by modifying the parameters of its own behaviour. This is why an autonomous entity is hereinafter referred to as an enaction object. The enaction is more precisely defined in the thesis by M. Parenthoën of the Université´ de Bretagne Occidentale, the title of which is “Animation phénoménologique de la mer”.

It is important to note, as will be seen in detail hereinafter, that the visualisation of the medium (in this case the sea) is only one option provided by the device D according to the invention. This results from the fact that a user (or observer) finds himself at the same conceptual level as the entities that produce the animation, and consequently constitutes an autonomous entity. In other words, the animation of the medium (in this case the sea) may take place independently of its visualisation. The visualisation of the sea should therefore specify “where” and “when” to observe “what” as a function of the phenomena which the user (or observer) wants to see and where he wants to see them, and is thus involved in creating the spatio-temporal and semantic structure of the medium.

The sea model, implemented as a multi-agent system interacting through the mediation of a medium generated by the autonomous entities, will now be described in detail.

A user, such as a sailor, for example, generally decides on his actions as a function of certain phenomena which he has observed and/or which he knows, either by experience or through information he has been given or read.

According to the invention, the phenomenological animation of the sea is a multi-model system in which each model is the result of the description of one phenomenon considered independently of the other phenomena. Each model describing a phenomenon must therefore verify a principle of autonomy. In other words, each phenomenon has to be “objectified” (or “reified”) into an autonomous entity having sensory motor and decisional capabilities specific to it.

All the autonomous entities, including the user (or observer), interacts in a multi-agent system (SMA) as defined for example in the documents by J. Ferber “Les systémes multi-agents : un apercu général”, Technique et Science Informatique, 16(8), p. 979-1012, 1997.

In an SMA of this kind each agent constitutes an autonomous entity which has sensory motor capacities and communicates with the environment determined by the other agents. The agents are located in the environment in which they evolve according to their own behaviour models which define their capacities of perception, action and decision as a function of internal characteristics and of their interactions with the environment.

The interactions are mediated by a medium the spatio-temporal structure of which is not predefined but is constructed as it goes along by the entities themselves. Each entity therefore contributes to the structure by creating a topology element, as a function of the requirements needed for its auto-adaptation. The whole made up of the different autonomous entities thus assigns properties to each topology element associated with each entity, and each entity adapts its own behaviour to the properties which it actually perceives in the environment by means of its associated topology element. A schematic example of the organisation of the entities, carrying out the physical simulation of the phenomena, is illustrated in FIG. 1.

More precisely, in the example shown in FIG. 1, “a”, “c ” and “d” denote autonomous entities of the organisation. Each entity (or enaction object) is defined by a triplet of active objects, the respective activities (or methods) of which translate what it seeks to perceive, its action on the world to be perceived by all the entities together, and what it becomes, in view of the properties actually perceived in said world.

Moreover, as indicated previously, each autonomous entity (a, b, c, d) is arranged so as to structure the medium by inserting therein a spatio-temporal topology element. This aptitude of the entities for structuring the medium constitutes their first role (or activity), hereinafter referred to as “aisthesis”.

The global topology of the medium is defined by the joining together of the spatio-temporal topological elements of all the entities.

Each autonomous entity (a, b, c, d) is furthermore arranged so as to act as a function of its own know-how on the global topology by attributing properties thereto. This aptitude of the entities to attribute properties to the medium constitutes their second role (or activity), hereinafter referred to as “praxis”.

Finally, each autonomous entity (a, b, c, d) is arranged so as to adapt its own behaviour as a function of the perceived characteristics of the medium, i.e. the properties of the topological element which it has created beforehand, which are determined by all the entities together. This aptitude of the entities to behavioural adaptation constitutes their third role (or activity), hereinafter referred to as “poiesis”.

The medium serves as an interaction mediator between the different autonomous entities of the organisation, which can only survive if the autonomous entities which constitute it activate their different roles of perceptive prediction, action on the medium and adaptation to the medium.

Reference will now be made to FIG. 2 in order to describe, by means of a UML diagram, the architecture which allows the simulation device D according to the invention to implement the organisation set out hereinbefore with reference to FIG. 1, when applied to the state of the sea.

The architecture shown is broken down into three levels. A first level N1 is dedicated to the scheduling of the activities of active objects. A second level N2 is dedicated to the virtual environment consisting of physical entities having natural phenomena the interactions of which are mediated by the medium. A third level N3 is dedicated to the specification of the virtual environment to the animation of the medium (in this case the sea).

The first level N1, also known as the simulator, comprises a scheduler (or sequencer) charged with managing the activities which poll the methods of objects implanted in a module M1, which will be described in detail hereinafter. The scheduler implements, as will be seen in detail hereinafter, a process of iterations which brings to life, in their turn, the active objects (or entities) that make up the virtual environment. The scheduler carries out asynchronous iterations in order to respect the autonomy of the entities and chaotic iterations so as to avoid introducing bias into the simulation.

The second level N2 is dedicated to the natural phenomena and their observation. It makes it possible to form the virtual environment from autonomous entities located in 3D space and in time. The virtual environment supplies the module M1 comprising the object methods. The autonomous entities (or enaction objects) interact via state objects which define interaction mediators proposing a spatio-temporal topological support enabling the virtual environment to pinpoint the interactions in space and time. All the interaction mediators together form what may be called the medium. The virtual environment has the task of solving the topological problems relating to the location of the entities and the interaction mediators, in order to answer the question “what is acting where and when?”. The natural phenomena which are intended to be simulated are objectified (or reified) into physical entities located in the virtual environment which ensure the physical coherence of the simulation of the natural phenomena. Furthermore, the observation of the natural phenomena is mediated by a measuring instrument supplied by a visualiser implanted in the third level N3.

As pointed out previously, each physical entity (or enaction object) has three particular methods (or activities): aisthesis enabling it to create interaction mediators collected into a topology element, praxis making it possible to give properties to each topology element located in its vicinity of influence, and poiesis making it possible to modify the behaviour of an entity or to create new entities.

Certain particular entities may also define instruments which can be used to observe the phenomena by measuring their effects on interaction mediators, the interaction then being that of the model with the user who may be a simple observer, an actor immersed sensorially or a modeller, through mediating the programming language. In the same way as the physical entities, the instruments may have access to the three methods described above, but most frequently the praxis may be neglected.

As pointed out previously, the third level N3 is dedicated to specifying the virtual environment to the animation of the medium (in this case the sea). It comprises on the one hand a module M2 defining the different types of physical entities (wave groups, breaking, current, local wind, bathymetry, synoptic (or synoptic wind), etc.), and secondly a module M3 defining the particles of water and the associated properties (dynamic position, mask, normal, wind, current, depth, turbulence, etc.), thirdly a module M4 defining the mediation medium which in this case is the sea and fourthly the visualiser which is a particular entity made up of a large number of specific particles of water forming a mesh of the surface of the sea which is to be observed, which have to be updated according to a selected frequency, preferably greater than or equal to 10 Hz, by the physical entities which make up the virtual environment, and notably by the wave groups, and textured as a function of the wave groups, the breaks and the local winds, via the measuring instrument.

In the presence of another application, it is this third level N3 which is adapted in accordance with the types of enaction objects (or entities), the state objects and the interaction mediators concerned.

Of the physical entities introduced previously, groups, breakings, winds, currents and bathymetry ensure the oceanographic coherence of the phenomena and their interaction via the properties of the particles of water (position, normal, wind, current, depth, turbulences etc).

As mentioned previously, each autonomous physical entity originates from the reification of a physical phenomenon (observed by sailors). As is diagrammatically shown in FIG. 3, these autonomous entities are located in the virtual environment and have their own behaviours. The behaviour model of an autonomous entity is associated with a prediction capacity, i.e. a time validity domain within which the behaviour of the entity does not require any fresh perception of the properties of the medium in order to remain physically correct. A knowledge of the time domain in which the autonomous entity can evolve in autonomy makes it possible to determine the frequency of the deeds of perception of this autonomous entity. Each entity knows therefore that it will need a given type of information which is pinpointed in time and at a given location, relative to its prediction.

Each “wave group” entity is controlled for example by a series of waves which gives it average characteristics (finite extension of the gaussian envelope in length and width, group velocity, number of waves, wavelength, period, horizontal profile of the crests, phase velocity, age of the group), to which are added local disturbances of phase and amplitude attached to the crests of the waves passing through it, in order to model the non-linear aspects of the waves.

As an example of an embodiment, the series of waves may be a Morlet 2D wavelet, the envelope of which moves at the velocity of the group while the phase of the sinusoidal layer progresses at the phase velocity. The Morlet 2D wavelet is one of the mathematical tools used by the simulation software (to which we will return later with reference to FIG. 5) and notably by its interaction mediators (water particles).

The wave group is sensitive to other autonomous entities which are, in particular, the breakings, currents, winds, bathymetry and the other wave groups.

As a wave group has to be able to carry out action transfers to the breakings, its predictive domain cannot therefore exceed the life of a breaking (the other phenomena being observable at a lower frequency). As marine or physical commonsense will estimate that the minimum duration of the wave breakings with a wavelength of more than 1 meter is about one second, it is possible for example to set the ability to anticipate of the model of the wave groups at one second. In this case the wave groups are charged with asynchronously activating their perceptive behaviours in a frequency of 1 Hz, in order to discover the evolution of the effects of the wave breaks, winds, currents and bathymetry on the properties of the medium which is to be perceived. In other words, the aisthesis of each wave group involved in the virtual environment is charged with creating at every second a topology element, consisting for example of five points distributed in its envelope (defining its spatial extension), the position of which is anticipated by 1 second.

Each wave break preferably occupies a surface of the body of water under observation, which is made up of contiguous elementary zones measuring 1 m² for example. Each zone may be associated with an active or passive phase of the breaking, depending on whether or not it belongs to the active front of this breaking. In each active zone a process of the production of foam and turbulence can be implemented as a function of the local activity of the breaking (the word “activity” used here should be understood in its physical sense of “production rate” and not in the computer sense), whereas in each passive zone a process of relaxation of the foam and turbulence may be implemented.

As the propagation of the active front of a breaking is a very dynamic process influenced by the waves and winds, the activity of the active zones (in this case 1 m²) may be updated at least twice per second, for example. As the dissipation of the foam and turbulence by contrast is much easier to predict (as it is only sensitive to the currents which carry them and the winds which direct them in trails of foam), and as the evolution of the winds and currents is fairly slow, the dissipation may be updated every 10 seconds, for example. Under these conditions the breakings activate their perceptive behaviours according to a frequency of 2 Hz on their active fronts in order to discover the effects of the groups (of waves) and the winds, and at a frequency of 0.1 Hz for their relaxation zones, in order to discover the effects of the currents and winds. In other words, the aisthesis of each breaking involved in the virtual environment is therefore charged with creating, on the one hand, each half second for its active front, a topology element consisting of particles of the active zones in order to cause the activity to evolve and in order to determine the end of the activity of each active zone, to which are added localised particles in advance of the active front and anticipating the propagation of the breaking, and on the other hand every 10 seconds, supplementary particles in the passive zones.

The entities consisting of the synoptic (or synoptic wind) and local winds evolve continuously over time in force and/or in direction, but the influence of the synoptic is global over the entire body of water under observation, on which it may create groups of waves, whereas the local wind is not involved in the creation of groups of waves and has a finite extension envelope which can move and transform. These entities, preferably modelled by descriptive models which are not sensitive to the medium, have no real need of perception. This is also the case, in a first approximation, for the currents and the bathymetry, owing to the fact that their parameters evolve exclusively as a function of time (tidal component). The physical entities are thus involved in creating the spatio-temporal structure of the medium and evolve autonomously therein between two acts of perception. One act of perception is characterised here by perceptive anticipation (“where and when will I need what?”) which precedes the observation of the properties of the medium, on the basis of which the entity in question adapts its behaviour. The interactions between the entities are thus mediated by the medium which they have created and to which each entity contributes by giving properties.

It is clear from the foregoing description that the computer model of the virtual sea is a heterogeneous multi-agent system (or SMA) made up of interacting physical entities. Each autonomous entity is located in the virtual environment and has its own behaviour, stemming from the reification of a physical phenomenon observed by sailors (wave group or groups, breaking or breakings, synoptic (wind), local winds, shallows, currents, etc.). Furthermore, the behavioural model of each entity is characterised by the predictive capacity as to what would ideally be the behaviour of the identity, corresponding to the frequency according to which the entity has to perceive its environment in order to adapt to changes in the medium.

The physical entities (or enaction objects) thus provide oceanographic coherence of the phenomena by interactions relying on the characteristics of the water particles (interaction mediators). Of these characteristics, particular mention may be made of the reference position, the dynamic position (updating by the physical entity “wave group”), the normal (updated by the physical entity “wave group”), the wind (updated by the physical entities “synoptic wind” and “local winds”), the current (updated by the physical entity “current”), the depth (updated by the physical entity “bathymetry”) and the density of the turbulences (updated by the physical entity “breaking”).

As indicated previously, the water particle constitutes the interaction mediator for the phenomenological simulation of the body of water (in this case the sea). It constitutes a topological support, referred to as a reference position in space/time. This reference position constitutes a point M (0, X₀) in space (where X₀is a vector), associated with a given moment to. These are the reference positions in space/time which are specified by the active perception activities of the autonomous entities during the creating of the spatio-temporal structure of the medium (the sea).

The sea with its knowledge of the water particles arranges them as fast as they are created in increasing order of moments to during which the entities anticipate the observation of the properties. An entity only acts on a particle located in time at moment to if this moment is within the range of validity of prediction of the model of the entity, i.e. between two acts of perception.

At a given moment, before carrying out their praxis, the entities take up their positions in space in accordance with their own behavioural models. The sea can then specify the activities of praxis of the entities at any moment by solving the spatial topology problems linked with the fact that a mediator belongs to the field of influence of each entity.

In order to reduce the complexity of O(n²) of these problems of spatial topology, where n is the number of interacting entities inherent in any multi-agent system, the body of water (the sea) can be divided into a regular grid of rectangular areas. This solution is useful on the assumption of a relatively homogeneous density of the entities which populate the body of water (the size of each rectangle is thus of the same order of magnitude as the average size of the entities that populate the virtual environment). When an entity uses a large number of interaction mediators in its topology element, as is the case with the entity that consists of the visualiser, it has to provide a specific method of solving the neighbourhood problems within its topology element.

In addition to the reference position of a water particle, the entity which creates this water particle specifies which type or types of property it needs using a mask. Thus, only those physical entities whose praxis influences a type of property are brought into action, thereby simplifying the complexity of resolution of the topological relationships between the entities and the interaction mediators by a first selection which is semantic rather than geometric.

A particle of water may have numerous properties such as for example its dynamic position about the reference position M(0,X₀), its velocity in relation to the sea, its perpendicular to the surface of the sea, the list of wave groups which influence it, the wind, the current, the depth, the thickness of turbulence and the list of breakings and the associated activities. For example the entities “wave groups” may act according to a particular model, possibly inspired by that described in the publication by F. J. Gerstner “Theorie der Wellen”, Abhandlungen der koniglichen bominschen, Gesellschaft der Wissenschafte, Prague 1804, notably in relation to the dynamic position, velocity and perpendicular. Furthermore, each wave group can be added to the list of wave groups if a particle of water is in its envelope. Furthermore, the entities “breakings” may act in accordance with a model of the type described in the publication by N. Reul et al “A model of sea-foam thickness distribution for passive microwave remote sensing applications”, Journal of Geophysical Research, 2004, notably with regard to the thickness of turbulence and the list of breakings and the associated activities.

Thus, each particle of water is located on the sea and in time by a reference position and has properties which are updated as a function of the praxis of the physical entities which influence it. The activity of the praxis is determined by the environment “sea” which has a knowledge of the positions of the particles of water and of the entities at every moment, by solving the neighbourhood equations between said water particles and entities. These water particles thus act as interaction mediators as their properties, originating from the influence of all the entities present, are used for each physical entity to adapt its own behaviour. The assembly of the particles of water is created by the entities as they interact. This assembly is perpetually evolving over time, both in the number of particles of water and in their positions in space, and form the medium in which the entities interact. FIG. 4 shows a diagrammatic example of the creation of the spatio-temporal structure of the medium “sea” by three entities (two wave groups and one breaking), by means of the aisthesis. In this Figure the particles of water which make up the medium (the sea) are represented by circles with different designs. In this example, at a given moment to, the entity breaking (break (t₀)) predicts that it will need, on the one hand in 0.5 seconds (i.e. t₀+0.5) properties of water particles on its active front ZA and in advance thereof in the direction of propagation, and on the other hand in 10 seconds (i.e. t₀+10), properties of the medium in its passive zone ZP (materialised by small dots). At a moment ti, the first wave group (group₁₃ 1(t₁)) predicts that it will have need of properties at the position (G1_estim) where it is supposed to be in one second (i.e. t₁+1). It then creates five particles of water for the moment t₁+1. Moreover, at a moment t₂, the second wave group (group_2(t₂)) predicts that it will have need of properties at the position (G2_estim) where it is supposed to be in one second (i.e. t₂+1). It then creates five particles of water for the moment t₂+1. The sea then causes all the entities to act on the spatio-temporal structure thus formed to give it properties.

As indicated previously, the device D according to the invention makes it possible to evolve the physical phenomena which characterise a medium (in this case the sea) without necessarily having to look at the medium. Similarly, the device D makes it possible to simulate some of the physical phenomena inherent in the surface of the sea independently of their visualisation, obviously putting aside the fact that the phenomena modelled depend on what one is looking to find. This results from the fact that the spatio-temporal structure of the medium (in this case the sea) created by the physical entities is adapted to the simulation of oceanographic phenomena and not to the interactive visualisation of the surface of the sea, which requires specific constraints on human perception and on the computerised means providing the interactive animation.

Visualisation of the medium (in this case the sea) in fact requires that the user be regarded as one of the active elements of the model. The visualiser must consequently constitute an autonomous entity participating in the organisation, immersed in the virtual environment by the mediation of a man/machine interface. As a result, the user has to specify the spatio-temporal structure of the medium, some of whose properties he wishes to observe (“where and when do I look at what?”). Depending on what he sees, the user decides on the next areas where he wishes to observe the selected phenomena. This step is the same as the one used by the autonomous entities which populate the virtual environment, which consists in carrying out active perception (or aisthesis).

Once the phenomena have been selected by the user, he has to stipulate, using the man/machine interface, “where” and “when” he wants to look at them. The information provided is supplied to a dedicated perception model. The minimum immersion is visual and is provided by the image of a virtual camera, for example. Interaction with the virtual camera can be envisaged for example using the control keyboard and/or the mouse. Moreover the camera may be attached to a fixed or movable object such as a boat, for example, on which an observer may possibly be located (or immersed).

In order to make the visualisation fluid it is preferable that the animation (in this case of the surface of the sea) is carried out in accordance with a perception model defined by a frequency greater than 10 Hz and a textured geometry structured into a mesh the points of which are distributed in accordance with a certain spatial probability distribution.

Once the perception model has been defined on the basis of the properties supplied by the man/machine interface, the sea can be instrumented by the entity “visualiser” (of the third level N3 of the architecture in FIG. 2). As indicated previously, the visualiser is in fact charged with structuring the medium (in this case the sea) as a function of the perception model and of recovering the properties pertinent to the visualisation of the surface of the sea. The projection of the properties observed by the entity “visualiser” thus enables the sea to be shown on the display monitor of the man/machine interface.

An entity “visualiser” represents a couple (geometry, camera). It will be supposed hereinafter that the number of points that constitute the geometry is fixed (it depends on the power of the computer equipment supporting the simulation device D), and that the topology of their respective neighbourhoods is maintained over time.

The positions of the points of the geometry are preferably generated in accordance with a probability distribution fixed by the perception model associated with the visualiser. The mesh is defined for example according to so-called static Delaunay triangulation carried out during the initialisation on default positions of the points. Such triangulation is described in particular in the publication by M. J. Castro et al “New progress in anisotropic grid adaptation inviscid and viscous flow simulation”, Technical Report 2671, INRIA, 1995.

The topological structure of the geometry is preferably static so that triangulation does not have to be carried out in flight. However, it is also possible to envisage that the grid of the topological structure be modified dynamically, level with the positions of the points which define it, for example using transformations which preserve the structural topology, other than simple translations, rotations or homotheties. To this end it is possible for example to use projections of the type described in the above-mentioned document by D. Hinsinger in order to adapt the representation of the details of the movement of the sea to the viewpoint of the camera.

The aisthesis activity of the visualiser consists in structuring the medium (in this case the sea) by generating, for example at least every tenth of a second, the topology element of which the associated water particles have as their reference positions the positions of the points on the grid determined by the perception model of the visualiser.

Building the image requires a knowledge at every point, firstly, of the dynamic position and of the perpendicular, in order to reconstitute the surface of the sea, and secondly of the thickness of the turbulence in order to show passive foam, thirdly of the activity of the breakings in order to allow adjustment of the flow of a system of particles of water (which is a graphical object that may consume a vast amount of resources and is consequently only instanced if its position places it in a perceptive attention zone specified by the perception model of the visualiser), fourthly the wind in order to allow parameterisation of the divergence of the generator of water particles and of the texture of wavelets (for example with “bump-mapping” of the type described in the document by J. Maillot et al “Interactive texture mapping”, computer Graphics (SIGGRAPH), 27: 27-34, 1993), and fifthly, wave groups, in order to allow the texturing of the waves when the pitch of the geometric grid is of an order of magnitude equivalent to the wavelength of the wave groups.

All the water particles which constitute the topological element of a visualiser, taken together, are generally too great for the physical entities which influence the grid to be able to solve the topological problems of their praxis without recourse to a specific method. As the spatial distribution of the reference points is not regular, a simple method based on encompassing boxes is not sufficiently effective to solve these problems.

Consequently, in order to simplify the complexity of the operation to resolve the problems, it is advantageous to use a binary tree process, for example of the “quad-tree” type as described in the document by A Klinger et al “Experiments on pictures representation using regular decomposition”, Computer Graphics and Image Processing, 5: 68-105, 1976. In this case the tree is preferably produced during the initialisation of the geometry, substantially at the same time as the triangulation.

These other topological structures remain fixed from a point of view of the neighbourhoods throughout the entire simulation, as they undergo only transformations which leave the notion of neighbourhood unchanged.

The entity “visualiser” thus enables a spatio-temporal structure to be given to the medium (in this case the sea), dedicated to human perception and giving access to the properties needed for the visualisation of the sea by revealing it using the display monitor. The revelation of the sea corresponds to the development of the photos of the praxis of the physical entities which populate it, as taken by the entity “visualiser”. This revelation depends chiefly on the characteristics of the graphics card of the display monitor and the fineness of the grain of the geometric mesh.

For a virtually real-time simulation (nine images per second) it is possible to use a graphics card supporting for example a “Vertex and Pixel shader” version 2.0, such as the GeForce FX card made by Nvidia, and a main processor operating at 1.4 GHz, such as for example the Pentium IV processor made by Intel. Only a few mega octets are then used in random access memory by the program, and the initialisation (triangulation etc.) typically takes about 15 seconds. With computer equipment of this kind a body of water about 4 km² can be covered with about 8000 interacting physical entities and the geometric grid may be made up of 6000 points. The complexity of the physical simulation of the interacting oceanographic phenomena is then, from the point of view of the CPU, of the same order of magnitude as that of the animation of the geometric grid.

Reference will now be made to FIG. 5 to describe an example of a simulation device D according to the invention, of the asynchronous and chaotic type, as mentioned hereinbefore, which is capable of implementing the architecture described hereinbefore with reference to FIG. 2.

As shown schematically and functionally in FIG. 5, the device D can be installed in a computer C comprising an operating system OS and processing and calculating means CPU adapted to operation in multi-task mode, such as that provided by the oRis environment described in particular in the document “Multi-agent system”, pages 499 to 524, RSTI-TSI, 21/2002. A multi-task environment of this kind is particularly well suited to programming by activated objects, for example in C++ or Java language. The oRis multi-task environment is coupled, like the device D shown, to a compiler (here referred to as the “object program compiler”). Moreover, the oRis environment may be coupled, like the device D shown, to a translator into C++ language (here known as the “object program interpreter”) in order to improve its efficiency by compilation. This interpreter may even be adapted so as to form an on-line compiler in which the code run is a code compiled online which can be dynamically modified. A multi-task environment of this kind, constituting a development of oRis, is known under the name ARéVi.

The device D comprises software for simulating the joint evolution of activated objects (here referred to as “general simulator”). More precisely, this simulation software (or general simulator) comprises the (first) objects known as enaction objects and the (second) objects known as state objects.

The simulation software (or general simulator) also comprises a simulation manager coupled with the state objects and enaction objects (or entities) and arranged so as to create its own scheduler or sequencer in order to work sequentially on a selection of enaction objects. The simulation manager calculates the interactions once the medium (in this case the sea) which gives rise to the enaction objects (or entities) has solved the topological problems.

The simulation manager is more precisely charged with activating, once only in each sequence, under the control of the sequencer (or scheduler) which it creates for the occasion, each selected enaction object, in an order which varies at least partly randomly from one sequence to the next, in order to apply each of its three activities to the current state of each state object which it designates in order to cause its state to evolve towards a new current state, or in other words in order to cause the spatio-temporal interactions between entities to evolve dynamically sequence by sequence.

In more detailed manner the user chooses first of all one or more enaction objects so that the device D simulates the spatio-temporal evolution of the system. This “preactivates” each enaction object selected within the simulation software.

Then, the simulation manager resets a sequence counter by placing the value n of the counter at 1 and creates a list of enaction objects. The first sequence (n=1) begins with a selection phase in which the simulation manager randomly selects one of the chosen enaction objects, which activates it instantly. Each activity (or method) of the enaction object selected and activated is then applied to the current state of each associated state object, thus possibly modifying its current state. Each activity is then activated and applied to each state object.

Then, the simulation manager deletes the enaction object which it has just applied from the list of enaction objects of the current sequence.

Then, the simulation manager runs a test intended to determine whether there are any remaining enaction objects to be applied in the list of enaction objects of the current sequence.

If the list of enaction objects in the current sequence is not empty, the simulation manager carries out a new selection phase for randomly selecting one of the remaining enaction objects. As indicated previously, it then activates this new selected enaction object and applies each of its activities to the current state of each state object, possibly modified by the activation of the previous enaction object (which can no longer be used in the current sequence). The simulation manager reproduces these operations (selection-activation, application and updating) as many times as there are enaction objects selected from its list of enaction objects, with the result that each activity of each enaction object is applied once to each state object with which it is associated. Once this has been completed, the first sequence (n=1), corresponding to the moment T=0, is complete.

When the list of enaction objects of the current sequence is empty, the simulation manager increases by one unit the current value n of the sequence counter. Of course, it runs a test on the number of sequences to be carried out. If the number of sequences carried out is equal to the maximum number envisaged, the simulation manager ends the simulation. By contrast, if there is at least one remaining sequence to be carried out, the simulation manager runs a new sequence corresponding to a moment T+1, T+2, . . . , T+n. It then reiterates the operations described above for each new sequence.

The duration of the simulation and hence the maximum number of sequences carried out by the simulation manager depends on the application in question or on the parameterisation selected by the user in view of the application. However, the simulation may be interrupted at any time by the user with the aid of a stop command sent to the simulation software through a man/machine interface of the computer C. It is important to note that a simulation interrupted on the command of a user can be resumed later.

It is important to note that the sequencer (or scheduler) can operate in virtual time or, in other words, that its functioning is not forced to respect real time, but each of its iterations represents logically, and not physically, a duration of 1 millisecond (1 ms). Naturally, the sequencer can also operate in real time. In this case, each of its iterations lasts physically for a selected period.

Because of the sequential and chaotic operating mode of the simulation software, the user can intervene in a simulation at any time, either in the form of an “avatar” for interacting himself with the object of the simulation, for example the medium, or in order to add to his selection or delete from his selection one or more enaction objects. The user can also decide to at least partially modify the definition (or structure) of one or more enaction objects. This gives the simulation software great interactivity.

The invention has a very large number of applications in numerous technical fields, and notably in the fields of assistance to navigation, naval architecture (for example for studying the behaviour of a boat or an offshore platform, as a replacement for and/or as a supplement to dock basins), for studying material resistance or undulatory phenomena (electromagnetic or acoustic waves). Thus, one possible application is the modelling of the combined interactions between a ship, radar waves and the sea when carrying out detection and/or reconnaissance of an object.

Moreover, in the foregoing text, there is a description of an application in which the heterogeneous medium was the subject of physical phenomena of the same nature. However, the invention also relates to applications in which the heterogeneous medium is the subject of a combination (or superimposing) of physical phenomena of different kinds.

The invention is not limited to the embodiments of the simulation device described above, solely by way of example, but encompasses all the variants which may be envisaged by the skilled man within the scope of the claims that follow.

1. Device (D) for simulating the time evolution of a medium, suitable for being implanted in a computer (C) arranged to support a programming by activated objects in a multi-task mode, characterised in that it comprises:
software for simulating by objects the joint evolution of at least some of said activated objects, comprising first objects known as “enaction” objects defining autonomous spatio-temporal entities each representing a physical phenomenon and, when activated, interacting within a multi-agent system via second objects known as “state” objects defining interaction mediators which provide a topological spatio-temporal support which forms a virtual environment representing the simulated medium and making it possible to detect the interactions between entities in space and time, and
a simulation manager capable of operating by sequences on a selection of enaction objects, and of activating each enaction object only once for each sequence, in an order which varies at least partially in a random manner from one sequence to the other, so as to cause the spatio-temporal interactions between the enaction objects to evolve dynamically sequence by sequence.

2. Device according to claim 1, characterised in that the simulation software comprises enaction objects defining instruments which constitute autonomous entities capable of measuring the effects on selected interaction mediators of at least some of said selected physical phenomena, represented by said entities, so as to allow the observation of said physical phenomena at selected locations in said medium.

3. Device according to one of claims 1 and 2, characterised in that each enaction object is defined by first, second and third active objects arranged so as to exert, respectively, a first activity intended to create a topological element consisting of at least one interaction mediator, a second activity intended to attribute properties to each topological element located in an area of influence of its enaction object, and a third activity intended to modify the behaviour of its enaction object as a function of the properties of the topology element which it has created, perceived within said medium and attributed by all said enaction objects which have constituted said medium.

4. Device according to claim 3, characterised in that each enaction object is associated with an adaptable parameterised behavioural model capable of defining a region of the medium where said properties of the topological element which it has created are to be perceived, and each moment during which said properties are to be perceived.

5. Device according to claim 4, characterised in that each perception moment is defined outside time validity ranges during which the behavioural model of the enaction object in question does not require any new perception of the properties of the topological element which it has created in order to remain physically correct.

6. Device according to claim 5, characterised in that said time domains are periodically spaced at a selected frequency proper to the enaction object in question.

7. Device according to one of the preceding claims, characterised in that said simulation software comprises a scheduler capable of operating in one of two modes selected from a real time mode, in which it operates according to a chosen frequency, and a virtual time mode, in which it operates periodically but for durations which are variable from one period to another.
